(19) United States
(12) Patent Application Publication
(10) Pub. No.: US 2010/0136894 A1
(43) Pub. Date: Jun. 3, 2010

(54) COIN STORAGE DEVICE

(75) Inventors: Roland Griese, Berlin (DE); Christian Trenner, Berlin (DE)

Correspondence Address: SCHWEGMAN, LUNDBERG & WOESSNER, P.A., P.O. BOX 2938, MINNEAPOLIS, MN, 55402, US

(73) Assignee: Walter Hanke Mechanische Werkstatten GmbH & Co. KG, Berlin (DE)

(21) Appl. No.: 12/523,429

(22) PCT Filed: Jan. 23, 2008
(86) PCT No.: PCT/EP2008/000756

§ 371 Date: Feb. 22, 2010

(30) Foreign Application Priority Data
Jan. 23, 2007 (DE) 10 2007 004 236.3

(51) Int. Cl. G07D 3/00; G07D 9/00

(52) U.S. Cl. 453/3; 453/63; 206/8; 206/445

(57) ABSTRACT

A coin storage device, which can be inserted in a coin testing device or in a cash register system, is described. The coin storage device comprises at least two opposing walls, wherein between the walls a shaft having a width is configured, and a track disposed in the shaft is provided. Of the two opposing walls, at least one is at least partially displaceable, and the width of the shaft can thus be varied. The track is arranged displaceably, and at least one retaining rail is provided, wherein the retaining rail is displaceably disposed above the track in the shaft. Such a coin storage device can be used to sort out foreign objects based on gravity. A coin storage device is possible for a coin testing device, and congestion by coins or foreign objects can be eliminated due to the variable width of the shaft.

The subject of the invention is a coin storage device for sorting out foreign bodies, for storing coins for a coin tester and for avoiding blockages by coins and/or foreign bodies.

Modern cash collection systems, such as are erected for example in car parks, essentially comprise a coin separator, a coin tester and a sorting system and also a coin dispenser. An indeterminate quantity of coins is hereby fed into the coin separator which separates the coins and passes the separated coins, one by one, to the coin testing unit. In the coin testing unit, a test is made as to whether the coin represents a coin which can be accepted by the machine or in fact forms a foreign body or counterfeit money. In the case of counterfeit money or foreign bodies, the counterfeit money or foreign body is, in the favourable case, passed directly to the ejection shaft of the arrangement. In the case of positive detection of a coin, the coin is passed to the sorting system and stored there. Furthermore, a number of coins determined by a control unit is issued in the coin dispenser.

Cash collection systems of this type are associated with a large number of disadvantages. A first problem resides in sorting out foreign bodies. Whereas the coin separator generally does not deal with whether an object represents a coin or a foreign body, this is in fact of great relevance for the coin testing unit. The problem is that many foreign bodies get caught in the insertion region of the coin testing device and thus prevent insertion of further coins into the coin testing unit. A blockage of coins of this type can often only be eliminated manually, which is associated with considerable maintenance costs. Furthermore, customer satisfaction suffers greatly with a cash collection system of this type.

A further problem of cash collection systems of this type is their speed. The speed of the coin separator is frequently hereby limited in that a coin must pass from the coin separator firstly through the coin testing device and through the sorting device before a device in the coin testing device gives a control command to the coin separator and a further coin is introduced into the system. By means of an additional retaining device, time can be saved since, at a further point in the system, a coin is already kept in reserve.

It is a further problem that, despite refined mechanisms for preventing more than one coin being able to pass through the coin separator at the same time, it occurs again and again that more than one coin blocks the insertion slot of the coin testing device. As in the case of a foreign body, often the functionality of such a cash collection system can be reinstated only by manual removal of the blockage.

By means of an additional coin storage device which is disposed between a coin separator and a coin testing device, the above-mentioned problems can be reduced or entirely eliminated in the case of a favourable design. It is the object of the present invention to form a coin storage device which can sort out foreign bodies in a simple manner, can make a coin available rapidly to the coin testing device and is able to eliminate a blockage caused by foreign bodies or a plurality of coins without manual intervention.

The object is achieved by a coin storage device according to claim 1.

The subject of claim 1 describes a coin storage device which comprises at least two oppositely situated walls, a shaft with a width being configured between the walls. Of the two oppositely situated walls, at least one wall is disposed at least partially movably. Furthermore, the width of the shaft can be varied. This has the advantage that a foreign body located in the shaft, which foreign body cannot move further because of its dimensions and is consequently trapped in the shaft, can be freed by altering the width of the shaft and can fall down the shaft and consequently be guided out of the shaft. The width of the shaft hereby can be altered in different ways, either by mechanical or electromechanical arrangements.

A track which is disposed movably is located in the shaft. Furthermore, a retaining rail is present, the retaining rail being disposed above the track, again movably in the shaft. A coin introduced into the shaft (there should also be included within this term objects similar to coins, such as a chip) hence falls firstly onto the retaining rail into a retaining position in which the coin is securely retained. There is understood by retaining rail or track hereby the support surface on which the coin is situated. If this retaining rail has for example a slightly inclined configuration, then foreign bodies, in particular small foreign bodies, can be guided out of the shaft sliding directly via the retaining rail, either at the side or downwards through an opening.

During a movement of the retaining rail, the latter is moved into such a position that the coin falls onto the track which is situated thereunder and configured separately. The track serves for the purpose of deflecting the direction of movement of the coin such that the latter is guided further into a coin testing unit or a device connected to the coin storage device. As a result of the fact that the track has a movable configuration, i.e. can be removed from the shaft, a foreign body or a coin which is too small can in fact fall entirely up to the end of the shaft and be removed.

Advantageous developments of the coin storage device are explained in the independent claims.

It is an advantageous development of the coin storage device that the movable wall is connected to a non-movable wall via hinges like a flap or in a parallel displaceable manner. An embodiment of the hinges such that the movable part can move like a flap is of advantage if the hinges are fitted on the lower end of the shaft. Since the shaft in the region of the retaining rail or of the track advantageously has a width which corresponds approximately to the width of the thickest coin which the coin storage device is intended to receive, the region of the shaft which is disposed at the level of the retaining rail or of the track is widened by folding up the movable part of the wall or the movable wall via a hinge fitted below and a foreign body can fall downwards through the shaft as a result of the widened shaft.

A similar mode of operation, as described above, can be achieved by a hinge arrangement which moves the movable part of the wall or the movable wall not like a flap but moves the entire part or the entire movable wall parallel out of its operating position and widens the shaft as a result. The operating position of the movable part of the wall or of the movable wall is hereby defined by the maximum width of a coin which is suitable for the coin storage device.

A further advantageous development of the invention is that the retaining rail has at least one non-operating position and one operating position. The non-operating position of the retaining rail hereby is such that the retaining rail closes the shaft at least in parts and the operating position of the retaining rail opens the shaft downwards. In the non-operating position of the retaining rail, a coin inserted into the shaft can be retained by the retaining rail such that the coin cannot alter its height. In the operating position of the retaining rail, the latter is moved in such a manner that the shaft is opened downwards and a coin lying on the retaining rail falls downwards because of the effect of gravity. It is hereby important, as described already in the previous developments, merely that the coin falls downwards because of the effect of gravity. This implies inter alia that the shaft need not lead vertically downwards but only needs to be formed in such a manner that the effect of gravity moves a coin downwards when the retaining rail is moved into the operating position. Various embodiments of the operating position are hereby possible.

A coin situated on the retaining rail does not contact the track since the track is disposed below the retaining rail. This means that the retaining wall absorbs the weight of the coin. As a result of the fact that the track and the retaining rail are at a spacing from each other in such a manner that a coin lying on the retaining rail is at a spacing from the track, the coin—in the operating position of the retaining rail—can accelerate whilst falling downwards so that when striking the track the coin already has an initial speed.

In addition—in the non-operating position of the retaining rail—any dirt present on the retaining rail, in particular in the case of an inclined arrangement of the retaining rail, can run off the retaining rail without falling onto the track and dirtying the latter. In this way, the track is kept free of dirt particles. It is advantageous thereby in addition if the track is disposed below the retaining rail and offset slightly laterally relative to the retaining rail. Thus the dirt can slide off the retaining rail laterally and, because of the lateral offset of the track, does not fall onto the latter. Furthermore, it is advantageous if the track likewise has an inclined arrangement, however a coin situated on the track deflects in a different travel direction from the retaining rail. As a result dirt falls down the retaining rail for example on the left, whereas a coin located on the track rolls to the right into a coin testing unit. In this way, the dirt is kept away from the coin testing unit at the same time.

The preceding development is advantageous in particular in conjunction with the following development. In this development, the track also has at least one non-operating position and one operating position, the track being disposed in the non-operating position such that the shaft is open towards the bottom and, in the operating position, the track closes the shaft at least in parts.

A further advantageous development of the coin storage device resides in the fact that a delimitation is present in the coin storage device approximately at the level of the retaining rail, and the retaining rail and the delimitation delimit a cavity which extends downwards in a wedge-shape. The advantage of this arrangement resides in the fact that coins of different sizes can be retained in a retaining position in a very simple manner due to the retaining rail and the delimitation. Foreign bodies which are too small thereby slip lower down into the cavity which extends in a wedge-shape or funnel-shape. The delimitation can thereby be formed both by a wall, for example by a delimitation of the shaft, or an additional element which is then termed further or second retaining rail.

A further advantageous development of the coin storage device is characterized in that the cavity is configured in such a manner that both the smallest and the largest coin of a set of coins suitable for the coin storage device are retained in their respective retaining position in the wedge-shaped cavity by the retaining rail and the delimitation. The wedge-shaped cavity is produced thereby such that a part of the volume which receives the smallest coin in its retaining position in the cavity is also a part of the volume which receives the largest coin in its retaining position. This means that the retaining positions of the smallest and of the largest coin overlap and the region in which the overlap takes place is defined as overlapping region. In order to establish whether a coin of the set of coins suitable for the coin storage device is present in the cavity, only a small partial volume of the cavity requires to be monitored. This monitoring can be implemented via an additional electronic control unit or a mechanical switch arrangement.

A further advantageous development of the invention is that a light barrier is present in the region of the cavity. It is particularly advantageous here if the light barrier is configured in the overlapping region of the suitable set of coins of the cavity. The advantage resides in the fact that it can be determined reliably whether an object of suitable size is present in the cavity. As a result, objects which are too large or too small can be excluded from the start.

In the case where the light barrier determines that no coin is present in the cavity, but the operator or an electronic unit is sure that an object must be located in the cavity, then the movable part of the wall or the movable wall is moved and the width of the shaft is altered in such a manner that the object can be removed from the shaft by falling downwards. This monitoring as to whether the object has fallen downwards is controlled advantageously by a second light barrier which is disposed below the track. It can hence be ensured that a foreign object which is too large or too small is no longer located in the upper part of the shaft.

A further advantageous development of the coin retaining device resides in the fact that the cavity has additional elements for centring coins. This is advantageous in particular when the additional elements are fitted at the delimitation. These additional elements can thereby be independently movable or can remain stationary in a position also. The additional elements advantageously have a wedge-shaped configuration such that, in a small partial portion, the opening of the cavity which extends downwards in a wedge-shape is tapered. In particular in the case of a wedge-shaped form of the additional element such that the wedge increases downwards in its width and hence narrows the opening in addition, the coins of the set of coins provided for the coin storage device are centred better and, at the same time, obtain a slight deflection in the direction in which they are intended to be passed on later to the fitted coin testing unit as soon as the retaining rail and the track have been moved into their respective operating position.

A further advantageous development of the coin storage device resides in the fact that the retaining rail is connected pivotably to the movable wall. The advantage resides in the fact that the retaining rail is disposed in the shaft for its non-operating position and, in the operating position, can be pivoted out of the shaft via the connection to the movable wall. This has an advantage in particular when a blockage takes place within the shaft and thus only the shaft requires to be altered in its width in that the movable wall is moved since it is ensured in this case that no more objects are located on the retaining rail.

This development is advantageous in particular when in addition the retaining rail is connected to the movable wall via a spring with a restoring force, the restoring force acting in a direction which counteracts the pivot direction of the retaining rail. This has the advantage in particular that the retaining rail assumes the non-operating position as its natural position and after it has been moved into the operating position, i.e. in the position opening the shaft, is displaced, after conclusion of the action which displaces the retaining rail into the operating position, automatically back into the non-operating position.

A further advantageous development resides in the fact that the track can be introduced into the shaft or withdrawn therefrom via a mechanism, in particular via a mechanical or electromechanical mechanism.

It is hereby particularly advantageous if the track which can be moved in and out is in operational connection with the retaining rail. This means that by moving the track inwards, i.e. by transition from the non-operating position into the operating position of the track, the retaining rail is transferred at the same time likewise from its non-operating position into its operating position. This operational connection can thereby be achieved directly via a mechanical action principle or indirectly via a control unit. In the case of an indirect control unit, the signal that the track is moving from the non-operating position into the operating position or vice versa, is passed on simultaneously to the retaining rail which then moves likewise from the non-operating position into the operating position or vice versa.

A further advantageous development of the coin storage device is provided in that an electronic control unit is present, which coordinates the movements of the track, of the retaining rail and of the movable wall and ensures the mode of operation of the coin storage device described in the previous paragraphs. It is thereby particularly advantageous if the electronic control unit performs a movement of the wall independently via electromechanical or mechanical connections so that manual maintenance in the case of a blockage of the shaft or a blockage of the shaft by a foreign body is no longer required.

Advantageously, a coin storage device of this type is part of a coin testing unit. The coin storage device is thereby disposed such in the coin testing unit that the end of the track of the coin storage device corresponds to the insertion slot of the coin testing unit.

The above-described coin storage device is used advantageously also in a cash collection system. The cash collection system hereby includes a coin separator, a coin testing unit with a coin storage device and a sorting device. The coin storage device in particular thereby helps to avoid a blockage, to sort out foreign bodies and to enable an altogether faster mode of operation of the cash collection system. A larger number of coins provided in the coin separator is thereby separated and, in many systems, can be supplied separately for the supply testing unit via a magnetic device. After a coin has been issued to the coin testing unit, the latter is tested as to whether it represents a suitable coin or a foreign object. In the case where it represents a suitable coin, the latter is passed on to the sorting system and sorted by the latter. After conclusion of the sorting, the sorting device emits a signal to the coin separator that a further coin is issued to the coin testing unit. With the additional device of the coin supplier, a further position is now located in the system, at which, on the one hand, foreign bodies can be sorted out even before the coin testing unit, which makes the operation of the coin testing unit more robust and faster, however a coin can also be supplied in fact at a further point. Thus actuation of the coin separator can take place for example via the coin storage device. Whilst the coin storage device conveys a coin from a coin separator, the coin which has been retained up till then in the coin storage device is tested in the coin testing device and transferred if necessary to the sorting device. When the sorting is completed, the sorting device emits a signal to the coin storage device that the coin testing unit can receive a new unit of coins or objects similar to coins. As a result, the entire sorting procedure is accelerated. Irrespective of the cash collection system, the coin storage device can of course undertake widening of the shaft also for maintenance purposes after each coin has been obtained in order to eject dirt or any foreign bodies. In most applications a cleaning application of this type is however unnecessary so that widening of the shaft need be undertaken only in the case of a blockage or when foreign objects are present.

Further advantageous developments are found in the further independent claims.

A method for controlling a coin storage device and sorting coins in a cash collection system is also intended to be dealt with in the following.

For clarification of features and advantages of the invention, an embodiment of a coin storage device is represented in the following. There are shown:

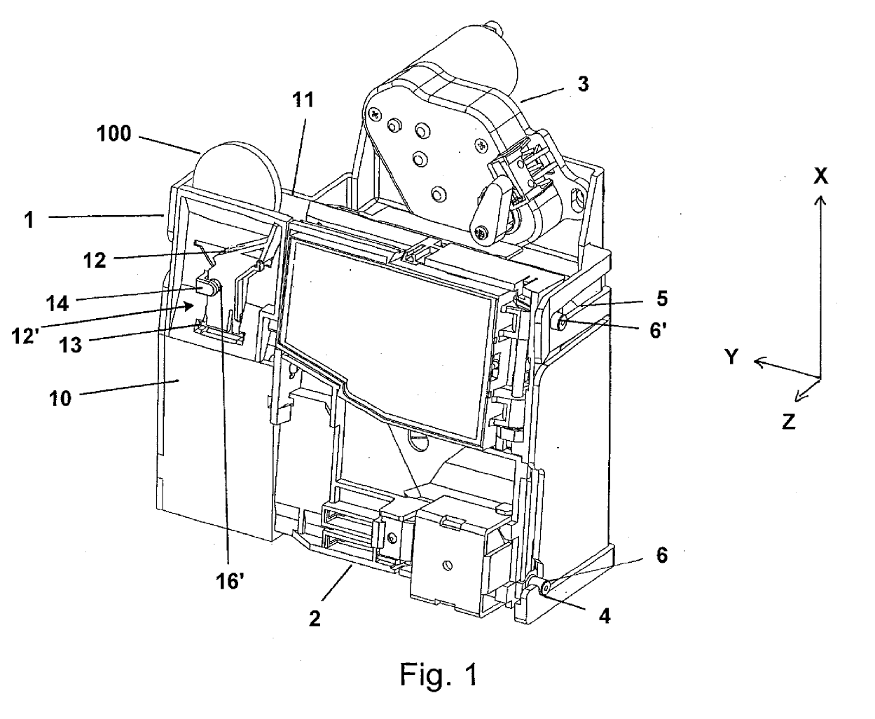

FIG. 1 a coin testing unit with coin storage device,

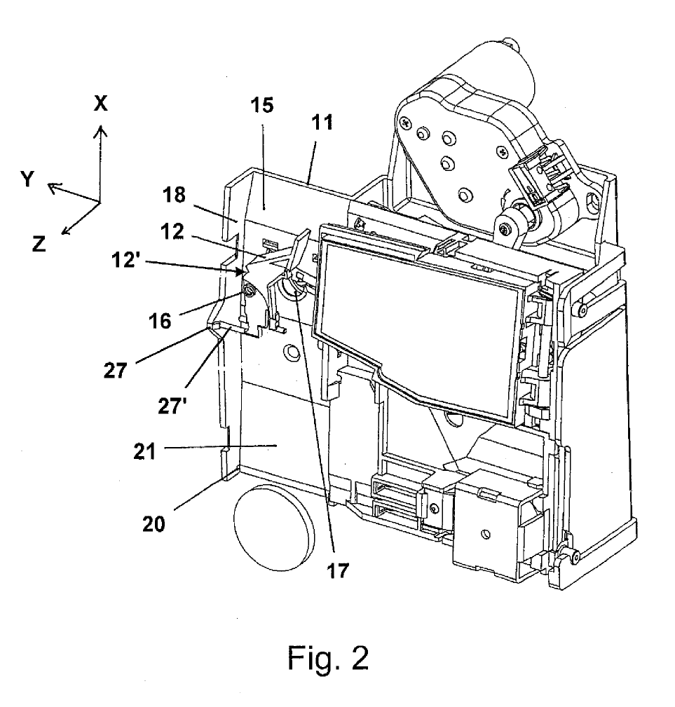

FIG. 2 a section in Z-direction of the coin testing unit with coin storage device,

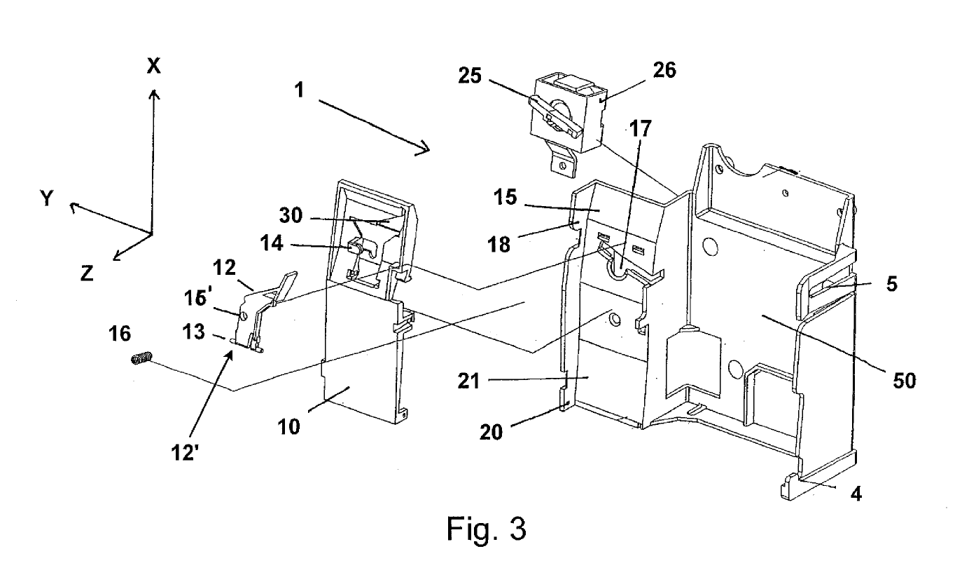

FIG. 3 an exploded view of a coin storage device,

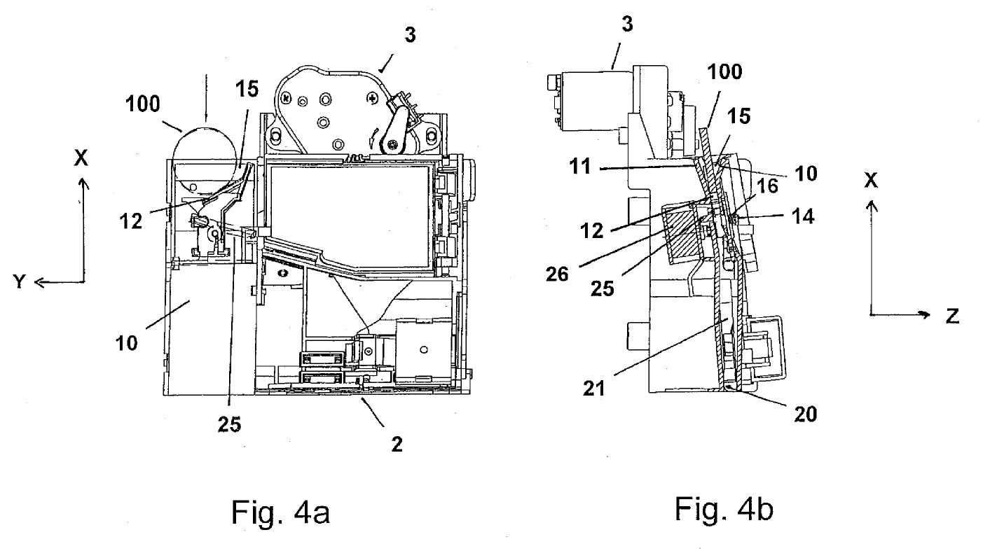

FIGS. 4a and 4b mode of operation of the coin storage device in non-operating position,

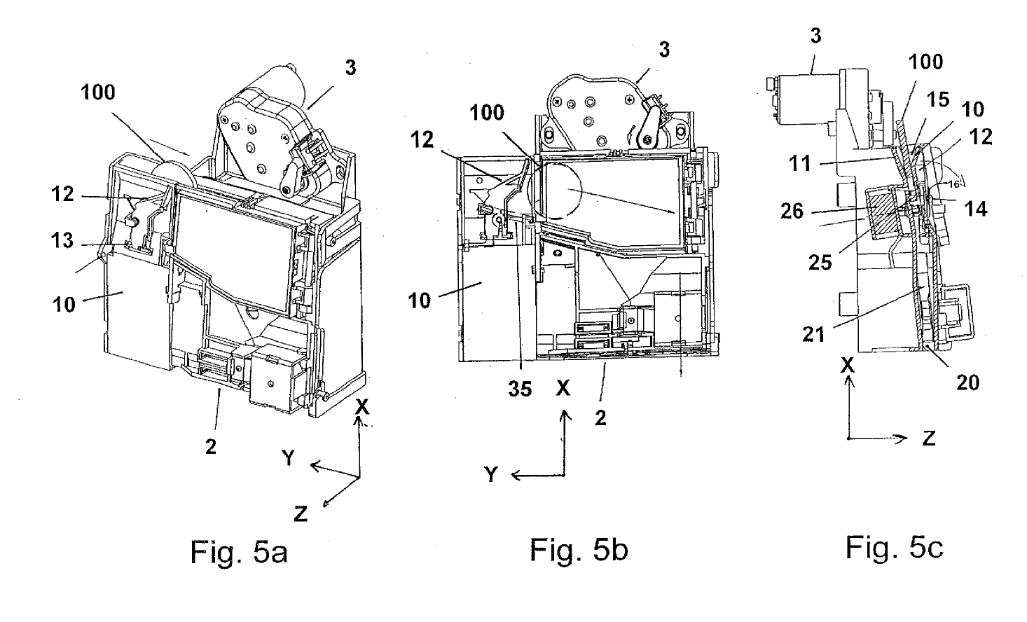

FIGS. 5a to 5c mode of operation of the coin storage device in operating position,

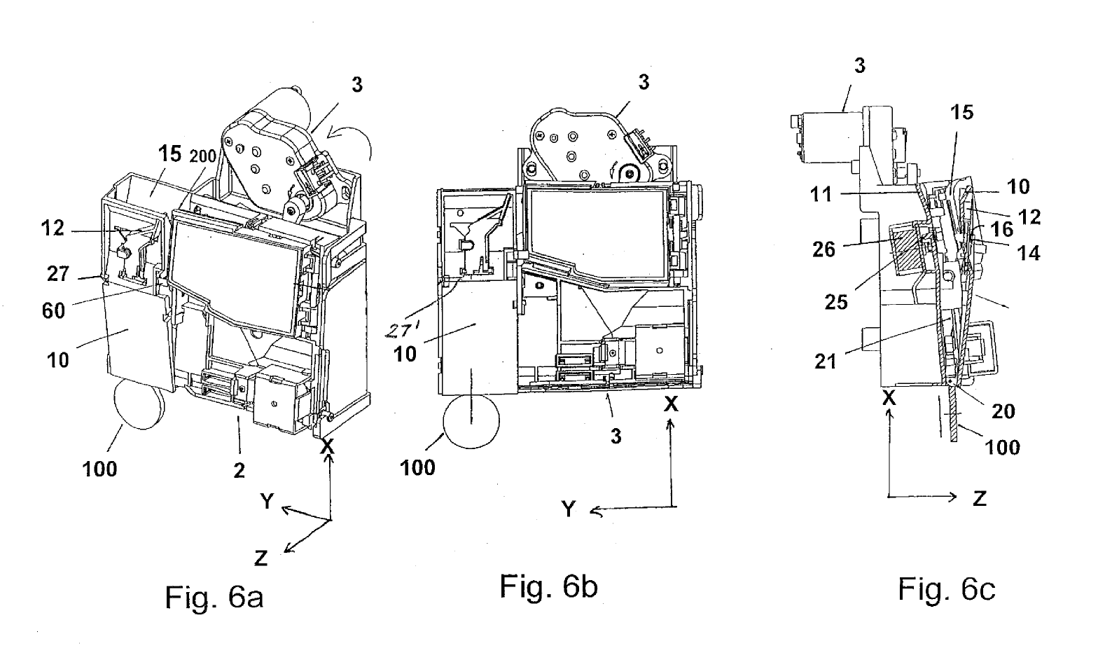

FIGS. 6a to 6c mode of operation of the coin storage device for eliminating a blockage,

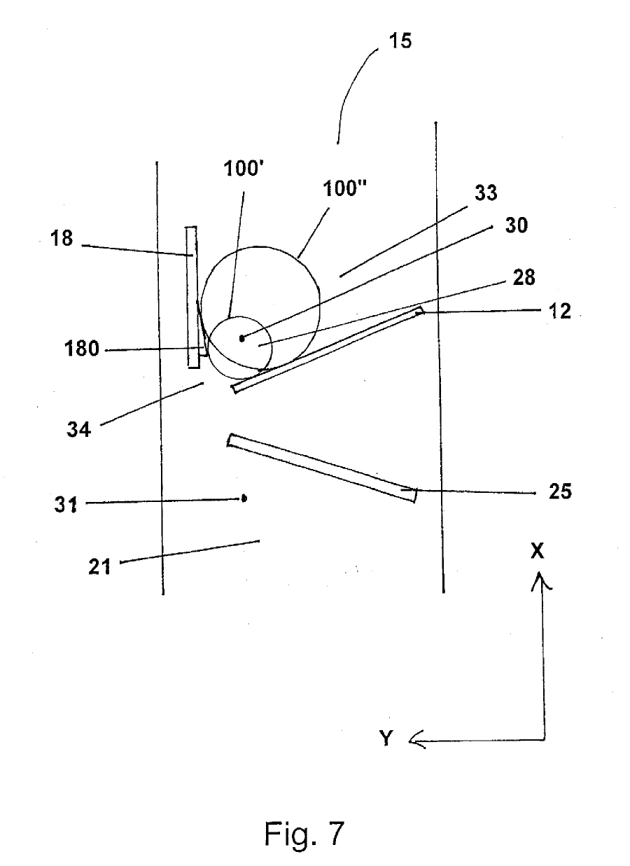

FIG. 7 a schematic shaft view of the coin storage device.

In FIG. 1, a coin storage device 1 which is in operational connection with a coin testing unit 2 is shown, the coin testing unit 2 having an eccentric drive 3, the mode of operation of which is of little relevance for the example illustrated here.

Recesses 4 and grooves 5 are visible in the coin storage device 1 in order to anchor the coin testing unit securely in the coin storage device 1. The anchorings hereby take place via the anchoring elements 6, 6′. Furthermore, a first movable wall 10 of the coin supply device is visible, a second non-movable wall 11 of the coin storage device and also a partially visible retaining rail 12 of the supply flap 12′ which is connected via a rotational connection 13 pivotably to the first wall 10. Furthermore, an element 14 which covers a hole 16′ in the supply flap 12′ is visible. Furthermore, a coin 100 which is located in the shaft 15 can be seen. It is retained at a height in the X-direction by the retaining rail 12.

In FIG. 2, the first movable wall 10 is removed and the shaft 15 becomes visible. The hinge elements 20 can be seen clearly, via which the movable wall 10 is connected to the non-movable wall 11. Furthermore, a spring 16 which was concealed in FIG. 1 by the element 14 which serves as counter-bearing is visible. The spring 16 engages through the hole 16′. The shaft 15 has, under a groove 17 which is provided for a track 25 which is not visible here (see FIG. 3), a lower part 21 which serves as ejector or supply to an ejector. Small foreign bodies hereby fall down the surface of the retaining rail 12 in the Y-direction and then vertically along the shaft 15 into the lower part 21 of the shaft. A delimitation 18 which is configured here by a side wall of the shaft 15 and which is moulded onto the stationary wall 11 can also be clearly seen.

Although a flap-like connection via the hinges 21 has been chosen here between the movable wall 10 and the non-movable wall 11, it is also conceivable that elements which displace the first wall 10 parallel to the non-movable wall 11 are mounted for example on the intermediate wall 18.

The side wall 18 has a stop boss 27 which cooperates with a lever 27′ moulded on the supply flap 12′. The lever 27′ is disposed below the axis of rotation of the supply flap 12′ prescribed by the rotational connection 13 so that a rocker action is produced when the lever 27′ presses against the stop boss, as a result of which, as described subsequently in connection with FIG. 6, the shaft is unblocked in addition.

An exploded view of the coin storage device 1 is shown in FIG. 3.

The non-movable delimitation wall 11 of the shaft 15 and the extension thereof is connected securely to a frame 50 for receiving the coin tester. The delimitation wall has the groove for engagement of the track 25, which is connected to an electromagnet 26, for travel thereof into the shaft 15 and travel out of the same. All the other parts have been described above.

It can be detected clearly that smaller objects would slide down the retaining rail 12 and would pass through between the delimitation 18 and the groove 17 for the track 25. In this way, smaller foreign bodies can be removed immediately from the coin storage device as a result of the effect of gravity thereon.

In FIGS. 4a and 4b which show a view on the coin storage device and the coin tester and a section in the X-direction of the coin storage device, a coin 100 which is retained on end on the retaining rail 12 can be detected, the coin 100 being held in its on-end position by the movable wall 10 and the non-movable wall 11. Furthermore, it can be detected clearly that the shaft 15 in the upper region is wider than in the region in which the retaining rail 12 is disposed. In the region of the retaining rail 12, the shaft 15 is only insubstantially wider than the coin 100 itself. Since the retaining rail 12 is located in its non-operating position, the spring 16 which is retained in position by the element 14 is released. Furthermore, the non-operating position of the track 25 can be detected, which is disposed in such a manner that it frees the shaft 15 and the latter is connected downwards directly to the lower part 21 of the shaft. Furthermore, it can be detected that the lower part of the shaft 21 is wider than the part of the shaft which is delimited in the X-direction by the retaining rail 12 and the track 25. Precisely in this region between the retaining rail 12 and the track 25, blockages can very easily occur in that more than one coin is introduced into the shaft 15, for example by malfunction of a coin separator. In unfavourable circumstances, the coin 100 will not move out of the non-operating position, the non-operating position of the coin 100 being established by the non-operating position of the retaining rail 12.

In FIGS. 5a, 5b, 5c, the coin storage device can be seen in its operating position. In the operating position, the retaining rail 12 is pivoted out of the shaft 15 via the hinges 13. As a result, the coin 100 can move from left to right into the coin testing unit 2 in FIG. 5a. This is indicated schematically in FIG. 5b. By pivoting the retaining rail 12 out of the non-operating position into the operating position and simultaneous introduction of the track 25 from the non-operating position into the operating position, the coin falls from the retaining rail 12 onto the track 25 and runs into the insertion slot of the coin testing unit 2. In FIG. 5c, the mode of operation can be detected better. In FIG. 5c, the track 25 is introduced into the shaft 15. By introduction of the track 25, the retaining rail 12 is pressed outwards since the track 25 is in operational connection with the retaining rail 12 via the supply flap 12′. In order to introduce the track 25 into the shaft 15, the electromotor or electromagnet 26 is put in operation. However, a mechanical drive is basically conceivable also for introducing the track 25 into the shaft 15. By pivoting the retaining rail 12 out, the spring 16 is pressed against the element 14, as a result of which a restoring force is built up in the spring 16 which endeavours to press the retaining rail 12 back into its non-operating position. From the other side, the track 25 presses against the retaining rail 12 and, as long as the electromotor or electromagnet 26 is in operation, prevents the spring 16 from being able to place the retaining rail 12 back.

However, it is also possible to pivot the retaining rail 12 out of the shaft 15 via an independent drive. An additional control unit is necessary hereby, which control unit emits a signal to the drive of the retaining rail 12 during introduction of the track 25 by the electromotor or electromagnet 26 so that said retaining rail is moved out of the shaft 15.

In FIGS. 6a, 6b, 6c, it is shown how a widening of the shaft by a flap-like movement of the movable wall 10 via the hinges 20 leads to a coin 100 passing through the lower part of the shaft 21 and being ejected downwards.

In FIG. 6a, it can be seen how the eccentric drive 3 performs a movement and consequently moves a flap element 200 of the coin testing unit 2 outwards in the Z-direction. The flap element 200 thereby grips a stop element 60 which is configured on the movable wall 10, and presses the latter outwards so that the shaft 15 enlarges in comparison to the widths shown in FIG. 4 and FIG. 5. Furthermore, the stop boss 27 which is in operational connection with the retaining rail 12 or supply flap via the lever 27′ indicated in FIG. 6b can be seen, such that the retaining rail 12 is moved into its operating position, i.e. is pivoted out of the shaft 15. The lever 27′ thereby comes into engagement with the stop boss 27 by pivoting the movable wall 10. By widening the shaft 15 and the simultaneous pivoting out of the retaining rail 12 and guidance of the track 25 out of the shaft 15, the coin falls through the shaft 15 via the lower part 21 downwards along the shaft, as indicated in FIG. 6b.

In FIG. 6c, the coin storage device 1 is cut in the XZ-plane. It can be seen clearly how the shaft 15 is greatly widened and the non-movable wall 11 and the movable wall 10 have a significantly greater spacing from each other. It can likewise be seen that the retaining rail 12 is pivoted out of the shaft 15 in its operating position. This is indicated by the tensioned spring 15. Furthermore, it can be seen that the track 25 is not disposed in the shaft 16. It can be easily imagined how a plurality of coins which have become wedged in the shaft 15 in the non-operating position or the operating position are ejected gradually downwards through the lower part of the shaft 21 because of the greater width of the shaft 15 in FIG. 6c. As a result, a possibility is provided, without manual intervention, of automatically removing blockages which arise because of a plurality of coins or a coin and a foreign body. It is hereby of advantage if an electronic control unit is present which, as a function of a signal transmitter which is disposed in the shaft 15, mutually coordinates the movement of the track 25, of the retaining rail 12 and of the flap element 200 of the coin testing unit. Of course, it is also hereby possible that the movable wall 10 or the non-movable wall 11 have a separate drive which can place the two walls at a spacing from each other in order to increase the width of the shaft 15. A signal transmitter which is disposed in the shaft in order to coordinate the individual movements mutually can be a light barrier.

In order to correlate FIGS. 4, 5 and 6 with each other, it can be used that respectively between two Figures, i.e. between FIGS. 4 and 5 and between FIGS. 5 and 6, respectively one control unit or sensor unit checks whether a coin is present at the position provided for it in the non-operating position or operating position. If this is not the case, the procedure of FIG. 5 is adopted, i.e. the width of the shaft 15 is enlarged so that any foreign bodies or coin blockages can be eliminated. In many configurations, it is however also sensible to undertake a widening of the shaft 15, the phase, shown in FIG. 6, of widening the shaft 15, after each individual coin which is present in the non-operating position on the retaining rail and in the operating position on the track, in order to remove any dirt or dirt particles or foreign bodies from the shaft 15 via the lower part of the shaft 21. This can be the case for example in bad weather conditions in which, because of the wetness of the coins, increased adhesion between the shaft walls and the wet coins arises.

However, it is generally better to undertake a widening of the shaft 15 only when an object can be established via a sensor unit, which object, although the retaining rail 12 is pivoted out of the shaft 15, is still located at a specific height above the retaining rail 12. It can be assumed in this case that either a blockage or some other malfunction is present and this can be eliminated in most cases by widening the shaft.

In FIG. 7, the shaft 15 with the lower part 21 is shown schematically in the XY-plane. A delimitation 18 can be seen which, in this embodiment, is disposed as an additional element in the shaft. Together with the retaining rail 12, the delimitation 18 forms a cavity 33 which extends downwards in a wedge-shape and has an opening 34 in the lower end. The delimitation 18 can also be formed by a side wall of the shaft, as shown in FIG. 2. It is apparent in addition that the opening 34 is located at the left edge of the shaft. Below the opening 34, only the lower part of the shaft 21 is located. The track 25 is disposed below the retaining rail 12 but offset so far to the right that an object falling through the opening 34 cannot be retained by the track 25.

It is also possible that the cavity 33 formed by the retaining rail 12 and the delimitation 18 has no opening 34. In this case, the foreign bodies accumulate in the corner which would be produced by the continuation of the elements 12 and 18. Upon opening the retaining rail 12 or pivoting out the retaining rail 12, the foreign bodies would then fall downwards.

Furthermore, the retaining position 100′ of a smallest coin of a set of coins envisaged for the coin storage device is illustrated in FIG. 7 and also the retaining position 100″ of a largest coin of the same set of coins. It can be detected clearly that the retaining position 100′ and 100″ coincide in the overlapping region 28. The overlapping region 28 is jointly formed by an additional element 180. By means of the additional element 180 which has a wedge-shaped configuration here, the wedge shape increasing downwards in the width thereof in the Y-direction, helps in the centring of the coins and with a robust mode of operation of the coin storage device 1. Furthermore, the direction of movement of the coins is changed by the additional element 180 in that the latter can fall subsequently more easily in the operating position of the retaining rail 12 onto the track 25.

The sensor unit mentioned in FIGS. 4, 5 and 6 for detecting the presence of a coin in the cavity 33 is formed in FIG. 7 by the light barrier 30 which is located in the overlapping region 28. This represents a particularly advantageous development of the invention since the presence of all sizes of coins located in the set of coins can thus be established by a single light barrier. In the presence of a coin, i.e. when the light barrier 30 is triggered, the retaining rail 12 is guided or pivoted out of the shaft 15, if possible after a short time span, and a coin present in the shaft 15 falls onto the track 25 which has been introduced into the shaft 15 in the interim and thus rolls into the insertion region of a coin testing unit 2.

In the case where the retaining rail 12 is pivoted out but the light barrier 30 still establishes the presence of an object, the track 25 only just brought into the operating position is moved back into its non-operating position and the movable wall 10 is moved so that the shaft 15 is widened and an object located in the region of the light barrier 30 can fall downwards. It is hereby sensible to configure a second light barrier 31 which can detect whether an object has fallen past it. In this case, the movable wall 10 would again close in order to produce the original width of the shaft 15 once again, and a new coin, for example from a coin separator, can be conveyed forwards. In the particularly advantageous embodiment of the second light barrier 31, this is fitted almost vertically below the light barrier 30 since it must be anticipated that an object falls along the direction of gravity.

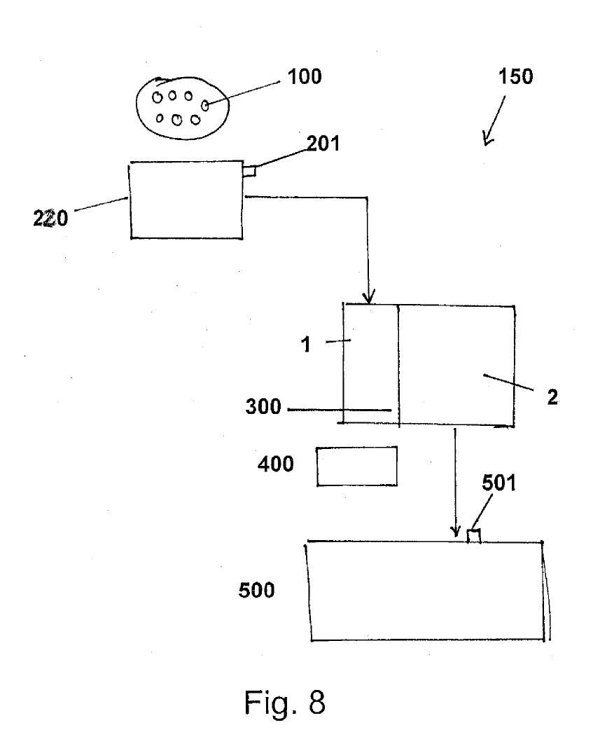

In FIG. 8, the advantageous use of a coin storage device 1 in a cash collection system 150 is also represented schematically. A non-specific quantity of coins 100 is thereby provided in a coin separator 220. The coin separator 220 separates the coins and retains these ready for the coin storage device. When a sensor 201 is activated by the coin storage device 1, an individual coin is passed on from the coin separator 220 to the coin storage device 1. In the coin storage device, foreign objects are sorted out, either in a passive manner by sliding downwards along the retaining rail 12 or by active widening of the shaft 15, as described in FIGS. 1 to 7. In the presence of a coin, the latter is retained until a sensor 501 of a sorting device 500 emits a signal to the coin storage device 1 that the latter can pass on the coin to the coin testing device 2. Counterfeit money or invalid chips or invalid coins or foreign bodies are thereby collected in the region 300 in a container 400. In the case where the coin testing device 2 has detected a coin, this is passed onto the sorting device 500 where it is then stored. By the additional retaining of a coin in the coin storage device 1, the coins are retained not only by the coin separator 220 but also in the coin supply device 1, fairly small foreign bodies and blockages being able to be eliminated at the same time in the coin storage device 1. This leads to faster processing of the money 100 by the cash collection system, as a result of which higher customer satisfaction can be achieved.

Furthermore, a cash collection system of this type can be operated almost without maintenance since blockages can be eliminated by the coin storage device 1 itself, as described in FIG. 6.

1. A coin storage device, in particular for a coin tester testers, comprising at least two oppositely situated walls, a shaft with a width being configured between the walls, and a track disposed in the shaft
and wherein at least one of the two walls is at least partially movable and the width of the shaft is able to be altered, the track is disposed movably and at least one retaining rail is present, the retaining rail being disposed above the track, movably in the shaft, in such a manner that a coin lying on the retaining rail is at a spacing from the track.

2. The coin storage device according to claim 1, wherein the movable wall is connected to the non-movable wall via hinges like a flap or in a parallel displaceable manner.

3. The coin storage device according to claim 1, wherein the retaining rail has at least one non-operating position and one operating position and is closed at least in parts in the non-operating position of the retaining rail of the shaft and is opened in the operating position of the retaining rail of the shaft.

4. The coin storage device according to claim 1, wherein the track has at least one non-operating position and one operating position and is opened in the non-operating position of the track of the shaft and is closed at least in parts in the operating position of the track of the shaft.

5. The coin storage device according to claim 1, wherein a delimitation is present and the retaining rail and the delimitation delimit a cavity which extends downwards in a wedge-shape.

6. The coin storage device according to claim 5, wherein the delimitation is formed by a wall or a further retaining rail.

7. The coin storage device according to claim 5, wherein the cavity which extends downwards in a wedge-shape has an opening at the bottom for guiding through foreign bodies which are smaller than the opening.

8. The coin storage device according to claim 5, wherein any coin of a set of coins which has at least one smallest and one largest coin can be received in the cavity and the smallest coin has a retaining position in the cavity and the largest coin a retaining position in the cavity, and an overlapping region is defined in the cavity by coinciding retaining positions of the smallest and of the largest coin.

9. The coin storage device according to claim 5, wherein at least one light barrier is present in the cavity.

10. The coin storage device according to claim 9, wherein the light barrier is configured in the overlapping region of the cavity.

11. The coin storage device according to claim 9, wherein at least one further light barrier is disposed below the track.

12. The coin storage device according to claim 4, wherein the cavity has additional elements for centring coins.

13. The coin storage device according to claim 1, wherein the retaining rail is connected pivotably to the movable wall.

14. The coin storage device according to claim 13, wherein the retaining rail which is connected pivotably to the movable wall has in addition a spring with a restoring force, the restoring force acting in a direction counter to the pivot direction of the retaining rail.

15. The coin storage device according to claim 1, wherein the track can be guided in and out of the shaft via a mechanism.

16. The coin storage device according to claim 1, wherein the track and the retaining rail are in operational connection.

17. The coin storage device according to claim 16, wherein the operational connection is controlled via a control unit.

18. The coin storage device according to claim 1, wherein an electronic control unit is present for coordination of the movements of the track and/or of the retaining rail and/or of the movable wall.

19. A coin testing unit, wherein a coin storage device according to claim 1 is present.

20. A cash collection system comprising a coin separator, a coin testing unit and a sorting device, wherein a coin storage device according to claim 1 is present.

21. A method for controlling a coin storage device which has at least two oppositely situated walls, a shaft with a width being configured between the walls and one of the two walls being configured movably, a movable track and a movable retaining rail being present, the retaining rail being disposed above the track, which method comprises:
checking whether an object is lying on the retaining rail of the coin storage device;
moving the retaining rail in such a manner that the shaft is opened and moving the track in such a manner that the shaft is closed; and
checking whether the object continues to lie on the retaining rail,
and when the object continues to lie on the retaining rail, actuating the movable wall in such a manner that the width of the shaft is enlarged and foreign bodies or jammed coins in the shaft fall downwards.

22. A method for sorting coins in a cash collection system, the cash collection system having a coin separator, a coin storage device, a coin tester, and a sorting system, the coin storage device having at least two oppositely situated walls, a shaft with a width being configured between the walls, and having a movable track and a movable retaining rail, the retaining rail being disposed above the track, which method comprises:
receiving the coins into the coin separator;
separating the coins in the coin separator;
transferring the separated coins from the coin separator to the coin storage device after conveying a coin through the coin storage device;
sorting out foreign bodies and eliminating blockages and storing the coin in the coin storage device;
conveying a coin through the sorting system and passing on the coin to the coin testing unit;
testing the coins in the coin testing unit; and
transferring the coins to the sorting system and sorting the coins.
